(19) United States
(12) Patent Application Publication
(10) Pub. No.: US 2025/0150544 A1
(43) Pub. Date: May 8, 2025

(54) CYLINDER SCANNER

(71) Applicant: Foxlink Image Technology Co., Ltd., New Taipei City (TW)

(72) Inventors: Yen Ya Wu, New Taipei City (TW); Yun Long Lai, New Taipei City (TW)

(21) Appl. No.: 18/771,085

(22) Filed: Jul. 12, 2024

(30) Foreign Application Priority Data
Nov. 8, 2023 (CN) 202323024691.2

(51) Int. Cl. H04N 1/06; H04N 1/00

(52) U.S. Cl. CPC H04N 1/0614; H04N 1/00533; H04N 1/0066

(57) ABSTRACT

A cylinder scanner includes a base, a contact image sensor module, a first roller unit, a second roller unit and an adjusting mechanism. The contact image sensor module is mounted on a middle of an upper surface of the base for scanning a cylinder. The first roller unit is slidably disposed above the middle of the upper surface of the base. The second roller unit is slidably disposed above the middle of the upper surface of the base. The adjusting mechanism is connected between the first roller unit and the second roller unit. When the cylinder is scanned, the first roller unit and the second roller unit rotate in the same direction, the cylinder is positioned on the first roller unit and the second roller unit, so the cylinder is driven by the first roller unit and the second roller unit to rotate.

### CROSS REFERENCE TO RELATED APPLICATIONS

The present application is based on, and claims priority from, China Patent Application No. 202323024691.2, filed Nov. 8, 2023, the disclosure of which is hereby incorporated by reference herein in its entirety.

### BACKGROUND OF THE INVENTION

### Field of the Invention

The present invention generally relates to a scanner, and more particularly to a cylinder scanner for scanning a surface of a cylinder.

### Description of Related Art

Referring to FIG. 12, in order to capture and store a pattern or a text on a surface of a cylinder 300 by a device 200, the surface of the cylinder 300 is scanned by a scanner device, or the surface of the cylinder 300 is photographed by a camera device. The device 200 is the scanner device or the camera device. When the surface of the cylinder 300 is photographed, it is customary to position the camera device parallel to the cylinder 300, then multiple images of the surface of the cylinder 300 are obtained by a way of rotating the cylinder 300, and finally, all the images are spliced together to obtain the pattern or the text on the surface of the cylinder 300.

However, a scanning result which is obtained by splicing the images together easily causes an obscure image condition or a splicing error condition at a splicing position of edges of the images. At the same time, the camera device must be spaced a certain distance from the cylinder 300 which is to be scanned to capture a complete image of the cylinder 300, so the entire camera device has a relatively large size, and the camera device is difficultly carried.

Therefore, it is necessary to provide a cylinder scanner for scanning a surface of a cylinder, the cylinder scanner has a smaller size and better image quality, and the cylinder scanner is easily carried.

### BRIEF SUMMARY OF THE INVENTION

An object of the present invention is to provide a cylinder scanner for scanning a surface of a cylinder. The cylinder scanner includes a base, a contact image sensor module, a first roller unit, a second roller unit and an adjusting mechanism. The contact image sensor module is mounted on a middle of an upper surface of the base for scanning a cylinder which is placed to the middle of the upper surface of the base. The first roller unit is slidably disposed above the middle of the upper surface of the base, and the first roller unit is parallel to the contact image sensor module. The second roller unit is slidably disposed above the middle of the upper surface of the base, and the second roller unit is parallel to the contact image sensor module. The adjusting mechanism is connected between the first roller unit and the second roller unit to adjust a distance between the first roller unit and the second roller unit. A vertical distance between the cylinder and the contact image sensor module is adjusted by adjusting the distance between the first roller unit and the second roller unit, so the cylinder is positioned on a top surface of the contact image sensor module. When the cylinder is scanned, the first roller unit and the second roller unit rotate in the same direction, the cylinder is positioned on the first roller unit and the second roller unit, so the cylinder is driven by the first roller unit and the second roller unit to rotate.

Another object of the present invention is to provide a cylinder scanner. The cylinder scanner includes a base, two opposite ends of the base protruding beyond a middle of an upper surface of the base to form two flanges; a contact image sensor module mounted on the middle of the upper surface of the base for scanning a cylinder which is placed to the middle of the upper surface of the base; a first roller unit slidably disposed above the middle of the upper surface of the base, the first roller unit being slidably mounted between two facing surfaces of the two flanges along a transverse direction; a second roller unit slidably disposed above the middle of the upper surface of the base, the second roller unit being slidably mounted between the two facing surfaces of the two flanges along the transverse direction; and an adjusting mechanism interconnected the first roller unit and the second roller unit to adjust a distance between the first roller unit and the second roller unit along the transverse direction, a vertical distance between the cylinder and the contact image sensor module being adjusted by adjusting the distance between the first roller unit and the second roller unit along the transverse direction, so the cylinder being positioned on a top surface of the contact image sensor module, wherein when the cylinder is scanned, the first roller unit and the second roller unit rotate in the same direction, the cylinder is positioned on the first roller unit and the second roller unit, so the cylinder is driven by the first roller unit and the second roller unit to rotate.

Another object of the present invention is to provide a cylinder scanner. The cylinder scanner includes a base, two opposite ends of the base protruding beyond a middle of an upper surface of the base to form two flanges; a contact image sensor module mounted on the middle of the upper surface of the base for scanning a cylinder which is placed to the middle of the upper surface of the base; a first roller unit slidably disposed above the middle of the upper surface of the base, the first roller unit being slidably mounted between two facing surfaces of the two flanges along a transverse direction; a second roller unit slidably disposed above the middle of the upper surface of the base, the second roller unit being slidably mounted between the two facing surfaces of the two flanges along the transverse direction; an adjusting mechanism interconnected the first roller unit and the second roller unit to adjust a distance between the first roller unit and the second roller unit along the transverse direction, a vertical distance between the cylinder and the contact image sensor module being adjusted by adjusting the distance between the first roller unit and the second roller unit along the transverse direction, so the cylinder being positioned on a top surface of the contact image sensor module; and an observation hole longitudinally penetrating through one of the flanges for detecting whether the cylinder abuts against the top surface of the contact image sensor module, wherein when the cylinder is scanned, the first roller unit and the second roller unit rotate in the same direction, the cylinder is positioned on the first roller unit and the second roller unit, so the cylinder is driven by the first roller unit and the second roller unit to rotate.

As described above, the cylinder scanner supports the cylinder which is to be scanned by the first roller unit and the second roller unit which are located on the upper surface of the contact image sensor module, and the distance between the cylinder and the contact image sensor module is adjusted by changing the distance between the first roller unit and the second roller unit, so that the cylinders with the different diameters are able to to be scanned. Furthermore, the cylinder is positioned on the first roller unit and the second roller unit, so the cylinder scanner has a smaller size and better image quality of an image of the cylinder, and the cylinder scanner is easily carried.

### BRIEF DESCRIPTION OF THE DRAWINGS

The present invention will be apparent to those skilled in the art by reading the following description, with reference to the attached drawings, in which:

FIG. 1 is a perspective view of a cylinder scanner in accordance with the present invention;

FIG. 2 is a partially exploded view of the cylinder scanner in accordance with the present invention;

FIG. 3 is a partially exploded view of an inner structure of the cylinder scanner in accordance with the present invention;

FIG. 4 is a partially exploded view of a first roller unit of the cylinder scanner in accordance with the present invention;

FIG. 5 is a partially exploded view of a second roller unit of the cylinder scanner in accordance with the present invention;

FIG. 6 is a partially sectional view of a contact image sensor module in accordance with the present invention;

FIG. 7 shows an action diagram of the cylinder scanner, wherein a cylinder with a small diameter is scanned by the cylinder scanner in accordance with the present invention;

FIG. 8 shows another action diagram of the cylinder scanner, wherein a cylinder with a big diameter is scanned by the cylinder scanner in accordance with the present invention;

FIG. 9 is a side view of the cylinder scanner, wherein the cylinder with the small diameter is scanned by the cylinder scanner in accordance with the present invention;

FIG. 10 is a side view of the cylinder scanner, wherein the cylinder with the big diameter is scanned by the cylinder scanner in accordance with the present invention;

FIG. 11 shows a schematic diagram of a calibration operation of the cylinder scanner in accordance with the present invention; and

FIG. 12 is a schematic diagram showing that a cylinder is photographed by a camera device or is scanned by a scanner device in prior art.

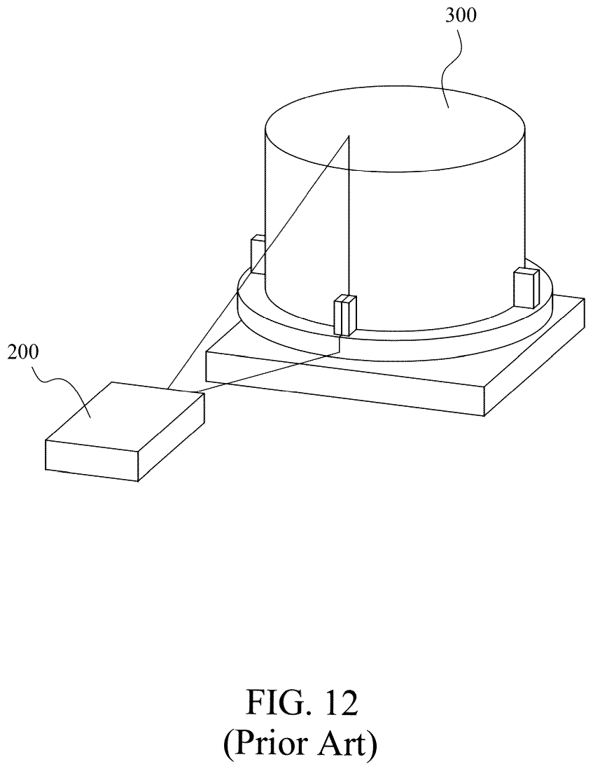

### DETAILED DESCRIPTION OF THE INVENTION

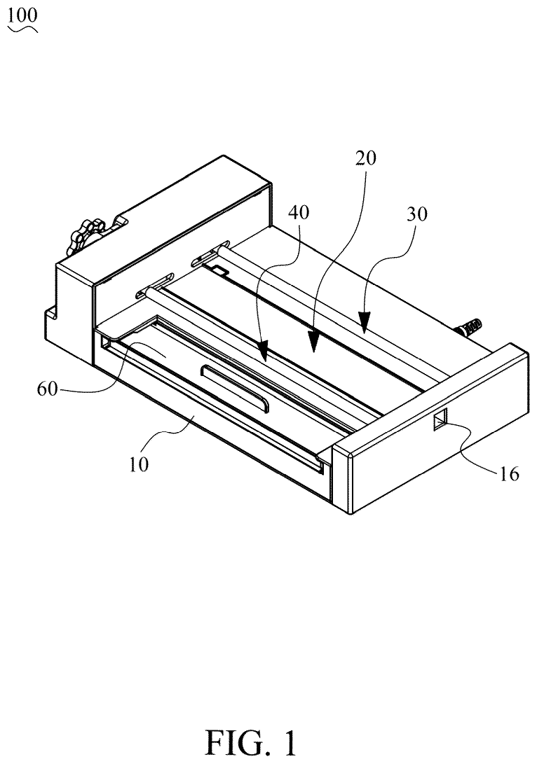

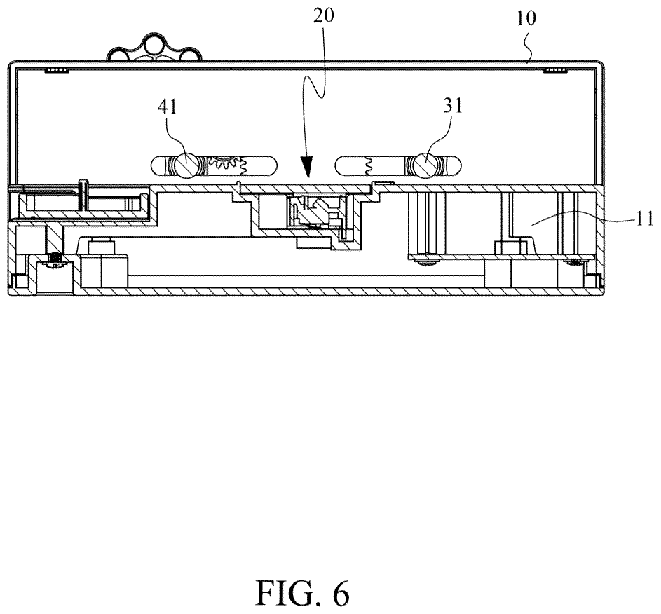

Referring to FIG. 1 to FIG. 6, a cylinder scanner 100 in accordance with the present invention is shown. The cylinder scanner 100 for scanning a surface of a cylinder 101, includes a base 10, a contact image sensor (CIS) module 20, a first roller unit 30, a second roller unit 40 and an adjusting mechanism 50.

An inside of the base 10 has an inner space 11. The contact image sensor module 20 is a rectangular shape. The contact image sensor module 20 extends longitudinally. The contact image sensor module 20 is mounted on a middle of an upper surface of the base 10 for scanning the cylinder 101 which is placed to the middle of the upper surface of the base 10. The first roller unit 30 extends longitudinally. The first roller unit 30 is slidably disposed above the middle of the upper surface of the base 10, and the first roller unit 30 is parallel to the contact image sensor module 20. The middle of the upper surface of the base 10 is lower than two opposite ends of the base 10. The first roller unit 30 is slidably mounted between two facing surfaces of the two opposite ends of the base 10. The first roller unit 30 slides along a transverse direction. The second roller unit 40 extends longitudinally. The second roller unit 40 is slidably disposed above the middle of the upper surface of the base 10, and the second roller unit 40 is parallel to the contact image sensor module 20. The second roller unit 40 is parallel to the first roller unit 30. The second roller unit 40 slides along the transverse direction. The adjusting mechanism 50 is disposed between the first roller unit 30 and the second roller unit 40, and the adjusting mechanism 50 is connected between the first roller unit 30 and the second roller unit 40 to adjust a distance between the first roller unit 30 and the second roller unit 40 along the transverse direction. The first roller unit 30 and the second roller unit 40 are positioned at opposite sides of the contact image sensor module 20. The first roller unit 30 and the second roller unit 40 are movable to close to the contact image sensor module 20, and movable to away from the contact image sensor module 20.

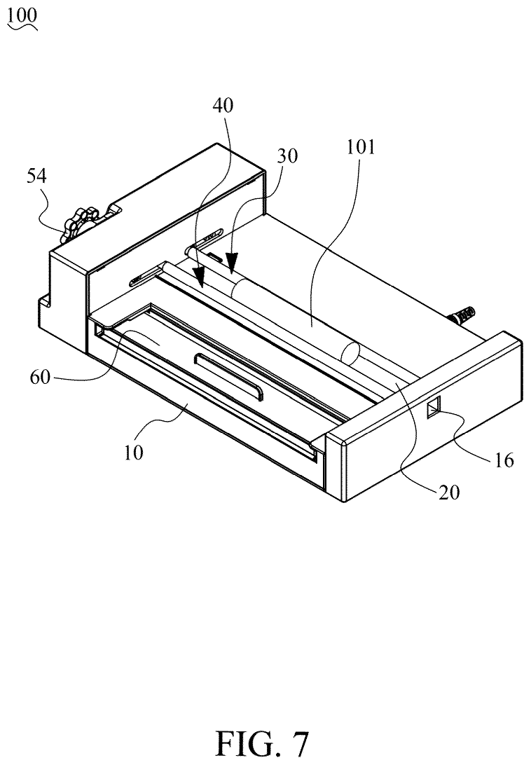

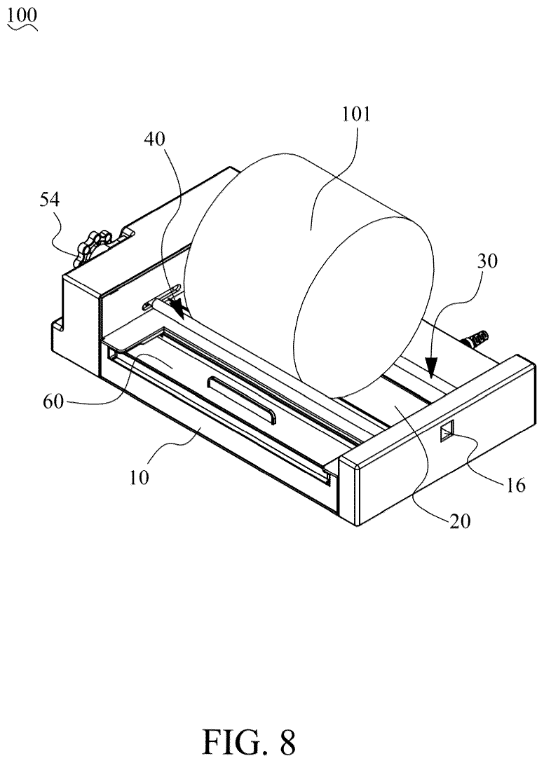

With reference to FIG. 7 and FIG. 8, a user places the cylinder 101 which is to be scanned between the first roller unit 30 and the second roller unit 40, and then a vertical distance between the cylinder 101 which is to be scanned and the contact image sensor module 20 is adjusted by adjusting the distance between the first roller unit 30 and the second roller unit 40 along the transverse direction, so the cylinder 101 which is to be scanned is positioned on a top surface of the contact image sensor module 20. Therefore, no matter what size the cylinder 101 which is placed to be scanned is, the cylinder 101 which is to be scanned is ensured to be attached on the top surface of the contact image sensor module 20.

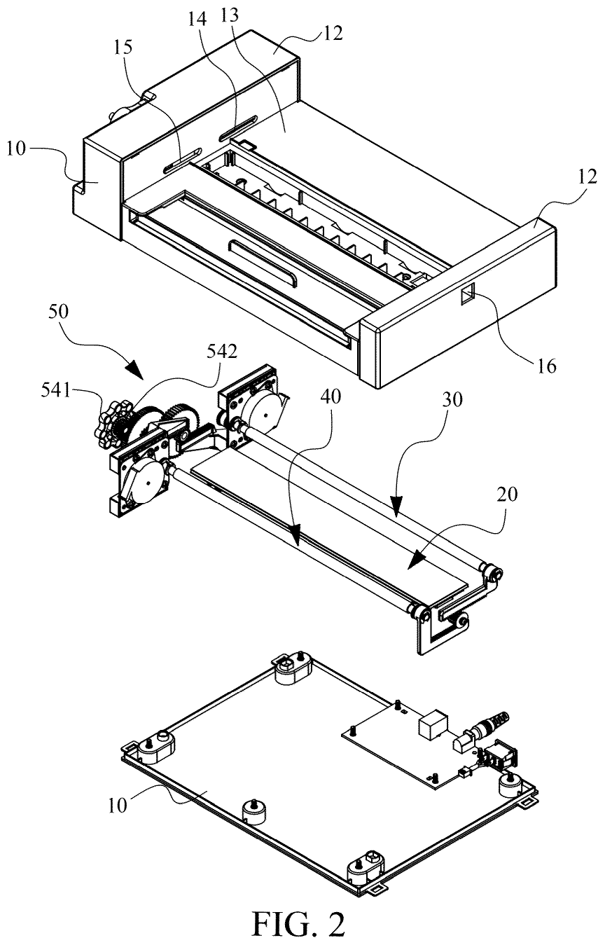

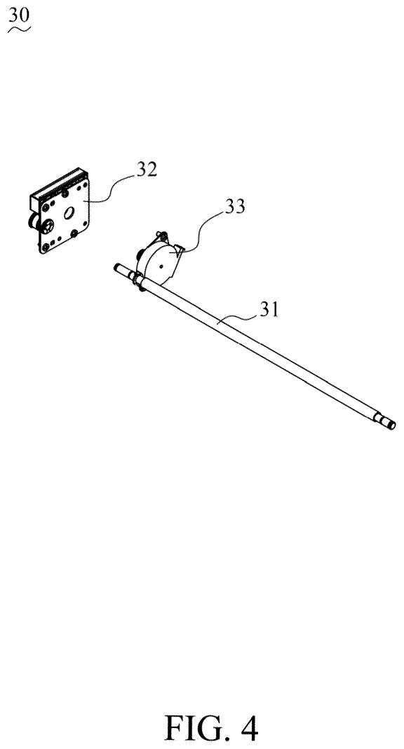

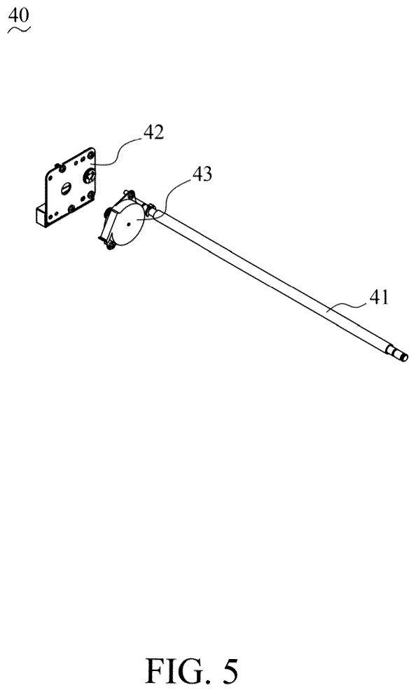

Referring to FIG. 1, FIG. 2, FIG. 4 and FIG. 5, the two opposite ends of the base 10 protrude beyond the middle of the upper surface of the base 10 to form two flanges 12. The two flanges 12 are spaced from each other to form an accommodating space 13 between the two flanges 12. The accommodating space 13 is formed among the middle of the upper surface of the base 10 and the two flanges 12. The first roller unit 30 is slidably mounted between two facing surfaces of the two flanges 12 along the transverse direction. The second roller unit 40 is slidably mounted between the two facing surfaces of the two flanges 12 along the transverse direction. The two facing surfaces of the two flanges 12 have two first sliding grooves 14 and two second sliding grooves 15. The contact image sensor module 20 is exposed to the accommodating space 13. The two first sliding grooves 14 face towards each other. The two first sliding grooves 14 are longitudinally aligned with each other. The two second sliding grooves 15 face towards each other. The two second sliding grooves 15 are longitudinally aligned with each other.

The first roller unit 30 includes a first roller element 31, a first supporting plate 32 and a first driving motor 33. Two opposite ends of the first roller element 31 are slidably mounted in the two first sliding grooves 14. The first roller element 31 is slidably mounted between the two first sliding grooves 14. The first roller element 31 slides between the two first sliding grooves 14. The first supporting plate 32 is mounted at one end of the first roller element 31. The first roller element 31 is located at an inner side of the first supporting plate 32. The first driving motor 33 is mounted to the first supporting plate 32 to drive the first roller element 31. The first driving motor 33 is located at an outer side of the first supporting plate 32.

The second roller unit 40 includes a second roller element 41, a second supporting plate 42 and a second driving motor 43. Two opposite ends of the second roller element 41 are slidably mounted in the two second sliding grooves 15. The second roller element 41 is slidably mounted between the two second sliding grooves 15. The second roller element 41 slides between the two second sliding grooves 15. The second supporting plate 42 is mounted at one end of the second roller element 41. The second roller element 41 is located at an inner side of the second supporting plate 42. The second driving motor 43 is mounted to the second supporting plate 42 to drive the second roller element 41. The second driving motor 43 is located at an outer side of the second supporting plate 42.

The first roller element 31 of the first roller unit 30 is placed in the two first sliding grooves 14, and the second roller element 41 of the second roller unit 40 is placed in the two second sliding grooves 15, so the first roller unit 30 is slidable in the accommodating space 13, and the second roller unit 40 is slidable in the accommodating space 13, and the distance between the first roller unit 30 and the second roller unit 40 along the transverse direction is changed. The first driving motor 33 is mounted at the first supporting plate 32, and the first driving motor 33 is connected with the first supporting plate 32, so the first driving motor 33 drives the first roller element 31. The second driving motor 43 is mounted at the second supporting plate 42, and the second driving motor 43 is connected with the second supporting plate 42, so the second driving motor 43 drives the second roller element 41. The first roller element 31 and the second roller element 41 rotate to bring along the cylinder 101 which is to be scanned to rotate.

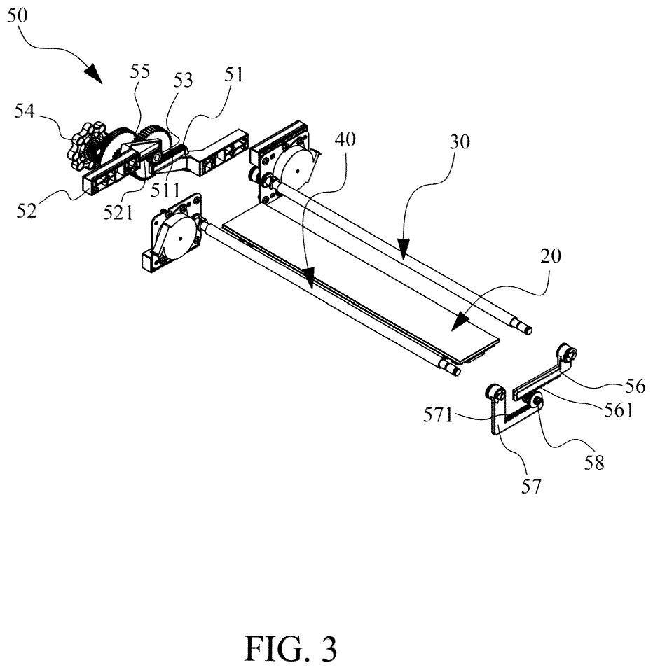

Referring to FIG. 2 and FIG. 3, the adjusting mechanism 50 includes a first rack 51, a second rack 52, a first adjusting gear 53, a knob gear 54, a transmitting gear 55, a third rack 56, a fourth rack 57 and a second adjusting gear 58. The first rack 51 is connected to one end of the first roller unit 30. An outer side of the first rack 51 is fastened to a rear surface of the first supporting plate 32 of the first roller unit 30. An inner side of the first rack 51 is disposed to the inner side of the first supporting plate 32 of the first roller unit 30. The inner side of the first rack 51 is connected to the inner side of the first supporting plate 32 of the first roller unit 30.

The second rack 52 is mounted to one end of the second roller unit 40. An outer side of the second rack 52 is fastened to a rear surface of the second supporting plate 42 of the second roller unit 40. An inner side of the second rack 52 is disposed to the inner side of the second supporting plate 42 of the second roller unit 40. The inner side of the second rack 52 is connected to the inner side of the second supporting plate 42 of the second roller unit 40. The inner side of the first rack 51 and the inner side of the second rack 52 are located between the inner side of the first supporting plate 32 and the inner side of the second supporting plate 42. The first rack 51 has a first tooth surface 511 which is defined at a top of the inner side of the first rack 51. The second rack 52 has a second tooth surface 521 which is defined at a bottom of the inner side of the second rack 52. The second tooth surface 521 is located above the first tooth surface 511. The first tooth surface 511 of the first rack 51 partially faces towards the second tooth surface 521 of the second rack 52. An inner side of the second tooth surface 521 of the second rack 52 is located above an inner side of the first tooth surface 511 of the first rack 51. The inner side of the first tooth surface 511 of the first rack 51 faces towards the inner side of the second tooth surface 521 of the second rack 52.

The third rack 56 is coupled to the first roller unit 30. An outer side of the third rack 56 is mounted around the other end of the first roller unit 30. The outer side of the third rack 56 is connected to the other end of the first roller unit 30. The outer side of the third rack 56 is connected to the other end of the first roller element 31. The first rack 51 and the third rack 56 are disposed to the two ends of the first roller unit 30, respectively.

The fourth rack 57 is coupled to the second roller unit 40. An outer side of the fourth rack 57 is mounted around the other end of the second roller unit 40. The outer side of the fourth rack 57 is connected to the other end of the second roller unit 40. The outer side of the fourth rack 57 is connected to the other end of the second roller element 41. The second rack 52 and the fourth rack 57 are disposed to the two ends of the second roller unit 40, respectively. The third rack 56 has a third tooth surface 561 which is defined at a bottom of an inner side of the third rack 56. The fourth rack 57 has a fourth tooth surface 571 which is defined at a top of an inner side of the fourth rack 57. The third tooth surface 561 partially faces towards the fourth tooth surface 571. An inner side of the third tooth surface 561 is located above an inner side of the fourth tooth surface 571. The inner side of the third tooth surface 561 faces towards the inner side of the fourth tooth surface 571.

The first adjusting gear 53 is disposed between the first rack 51 and the second rack 52, and the first adjusting gear 53 is engaged with the first rack 51 and the second rack 52 simultaneously. The second adjusting gear 58 is disposed between the third rack 56 and the fourth rack 57, and the second adjusting gear 58 is engaged with the third rack 56 and the fourth rack 57 simultaneously. The knob gear 54 is pivotally connected to an outer surface of the base 10 to rotate the knob gear 54 by the user. The knob gear 54 is rotatable by the user. The knob gear 54 has a knob end 541, and a gear end 542 connected with a middle of a front surface of the knob end 541. The gear end 542 of the knob gear 54 is engaged with the transmitting gear 55. The knob end 541 of the knob gear 54 is exposed outside to the outer surface of the base 10. The knob end 541 is provided for a user to rotate the knob gear 54. The transmitting gear 55 is connected between the knob gear 54 and the first adjusting gear 53. A front end of the transmitting gear 55 is engaged with a rear end of the first adjusting gear 53. A rear end of the transmitting gear 55 is engaged with the gear end 542 of the knob gear 54. A front end of the first adjusting gear 53 is connected between the first tooth surface 511 of the first rack 51 and the second tooth surface 521 of the second rack 52. The front end of the first adjusting gear 53 is engaged with the first tooth surface 511 of the first rack 51. The front end of the first adjusting gear 53 is engaged with the second tooth surface 521 of the second rack 52. The front end of the first adjusting gear 53 is engaged between the first tooth surface 511 of the first rack 51 and the second tooth surface 521 of the second rack 52.

Therefore, when the user rotates the knob end 541 of the knob gear 54, the knob gear 54 drives the transmitting gear 55 and the first adjusting gear 53 to rotate, and the first adjusting gear 53 drives the first rack 51 and the second rack 52 to slide, so that the distance between the first roller unit 30 and the second roller unit 40 along the transverse direction is changed. The third rack 56, the fourth rack 57 and the second adjusting gear 58 which are positioned at the other end of the first roller clement 31 and the other end of the second roller element 41 ensure that the first roller unit 30 and the second roller unit 40 slide more smoothly.

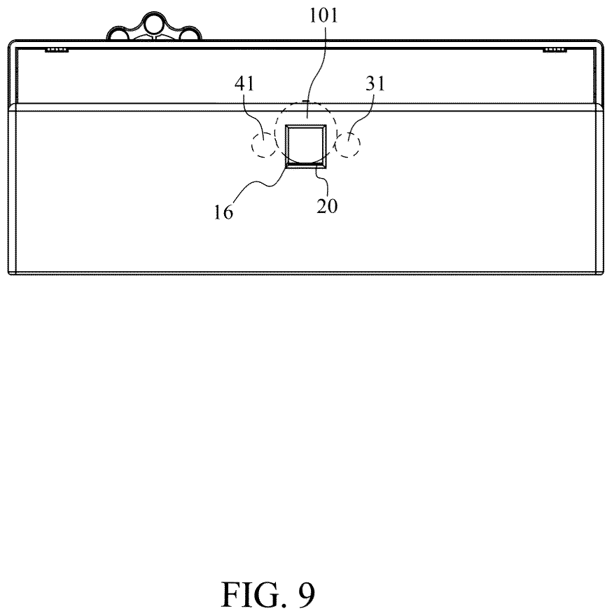

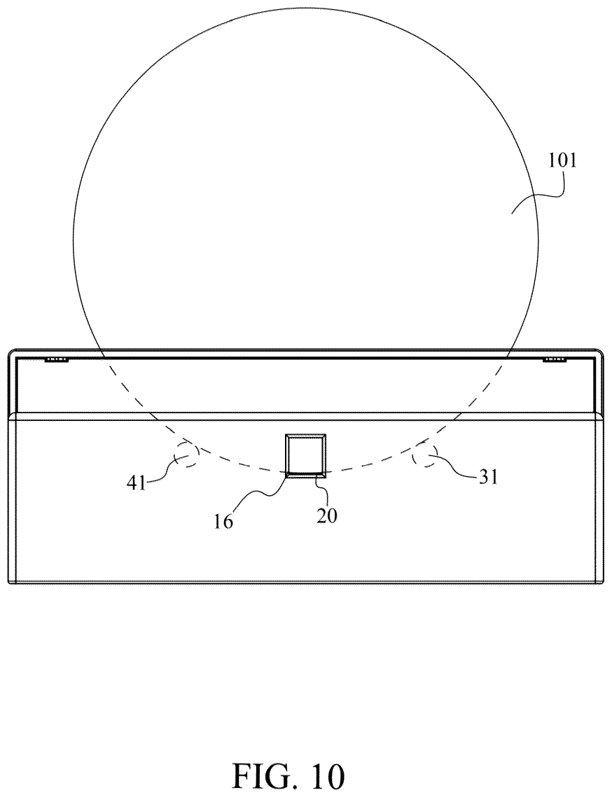

Referring to FIG. 2 to FIG. 10, a rear flange 12 which is adjacent to a rear end of the contact image sensor module 20 has an observation hole 16 longitudinally penetrating through the rear flange 12 for detecting whether the cylinder 101 abuts against the top surface of the contact image sensor module 20. The observation hole 16 is located to one end of the contact image sensor module 20, specifically, the observation hole 16 is located to a rear end of the contact image sensor module 20, so that the user is able to check whether the cylinder 101 which is to be scanned abuts against the top surface of the contact image sensor module 20 through the observation hole 16.

When the cylinder 101 is scanned, the first roller element 31 of the first roller unit 30 and the second roller element 41 of the second roller unit 40 rotate in the same direction, the cylinder 101 is positioned on the first roller element 31 of the first roller unit 30 and the second roller element 41 of the second roller unit 40, so the cylinder 101 is driven by the first roller element 31 of the first roller unit 30 and the second roller element 41 of the second roller unit 40 to rotate at a constant speed, and the cylinder 101 rotates at an original position, simultaneously, the contact image sensor module 20 captures an image of the cylinder 101. When the cylinder 101 is driven by the first roller element 31 and the second roller element 41 to rotate, a depth of field of the contact image sensor module 20 keeps consistent on account of a constant center point characteristic, better quality of the image of the cylinder 101 is acquired. In addition, the distance between the first roller element 31 and the second roller element 41 along the transverse direction is increased or decreased by manually rotating the knob end 541 of the knob gear 54, so that the cylinders 101 with different diameters are all able to complete functions of scanning surface patterns of the cylinders 101.

One side of the cylinder scanner 100 further has a power hole (not shown), a USB (Universal Serial Bus) hole (not shown) and a power switch (not shown). Specific steps of scanning the cylinder 101 by the cylinder scanner 100 are described as follows.

Connect a power cable (not shown) to the power hole, and connect a USB cable (not shown) to the USB hole to connect the cylinder scanner 100 to a computer (not shown), and then the power switch is turned on.

Position the cylinder 101 of which the surface pattern is to be scanned between the first roller element 31 and the second roller element 41.

Inspect whether a surface of the cylinder 101 is attached to the top surface of the contact image sensor module 20 through the observation hole 16, and rotate the knob end 541 of the knob gear 54 manually to make the knob gear 54 rotate clockwise or anticlockwise to increase or decrease the distance between the first roller element 31 and the second roller element 41 along the transverse direction, so that a purpose of attaching the surface of the cylinder 101 to the top surface of the contact image sensor module 20 is realized.

Press down a scanning key of the computer, the first roller element 31 and the second roller element 41 rotate in the same direction to drive the cylinder 101 to rotate, the contact image sensor module 20 captures the image of the cylinder 101 synchronously, after the surface pattern of the cylinder 101 is completely captured by the contact image sensor module 20, a scanning of the cylinder 101 is completed by the cylinder scanner 100.

When the cylinder 101 which is to be scanned is without contacting the top surface of the contact image sensor module 20, the knob end 541 of the knob gear 54 is rotated, the distance between the first roller unit 30 and the second roller unit 40 along the transverse direction is increased to lower the cylinder 101 which is to be scanned.

When the cylinder 101 which is to be scanned is positioned too low to make the cylinder 101 be without contacting the first roller unit 30 and the second roller unit 40, the knob end 541 of the knob gear 54 is rotated to decrease the distance between the first roller unit 30 and the second roller unit 40 along the transverse direction so as to ensure that the cylinder 101 which is to be scanned is in contact with the first roller unit 30 and the second roller unit 40 simultaneously.

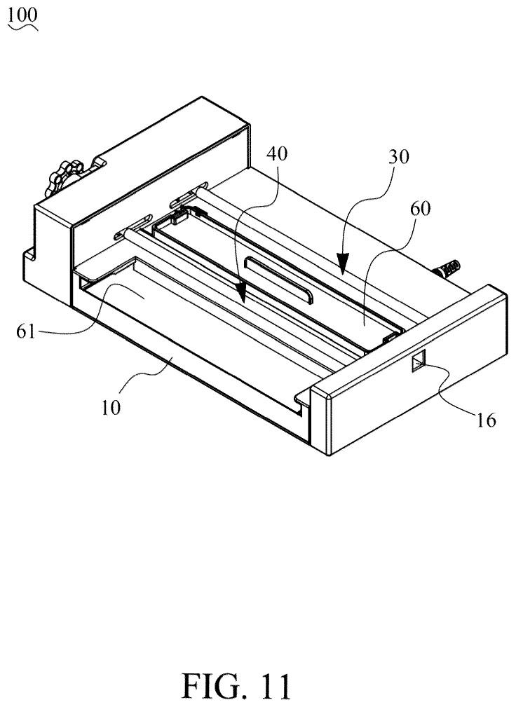

Referring to FIG. 11, the middle of the upper surface of the base 10 is recessed downward to form a holding slot 61 penetrating through one side surface of the base 10. The holding slot 61 is located to one side of the contact image sensor module 20. The cylinder scanner 100 further includes a calibrator 60. The calibrator 60 is detachably accommodated in the holding slot 61. The calibrator 60 has a plain white underside for a color reference. If the user considers a color of the image of the cylinder 101 is abnormal, the calibrator 60 is taken from the holding slot 61, and the calibrator 60 is positioned on the top surface of the contact image sensor module 20 to proceed with a caliabration. Specifically, when a white balance of the cylinder scanner 100 needs recalibrating, the user takes the calibrator 60 from the holding slot 61, the user places the calibrator 60 on the top surface of the contact image sensor module 20, and the user recalibrates scanning parameters.

As described above, the cylinder scanner 100 supports the cylinder 101 which is to be scanned by the first roller unit 30 and the second roller unit 40 which are located on the upper surface of the contact image sensor module 20, and the distance between the cylinder 101 and the contact image sensor module 20 is adjusted by changing the distance between the first roller unit 30 and the second roller unit 40, so that cylinders 101 with different diameters are able to be scanned. Furthermore, the cylinder 101 is positioned on the first roller element 31 of the first roller unit 30 and the second roller element 41 of the second roller unit 40, so the cylinder scanner 100 has a smaller size and the better image quality of the image of the cylinder 101, and the cylinder scanner 100 is easily carried.

What is claimed is:

1. A cylinder scanner, comprising: a base; a contact image sensor module mounted on a middle of an upper surface of the base for scanning a cylinder which is placed to the middle of the upper surface of the base; a first roller unit slidably disposed above the middle of the upper surface of the base, and the first roller unit being parallel to the contact image sensor module; a second roller unit slidably disposed above the middle of the upper surface of the base, and the second roller unit being parallel to the contact image sensor module; and an adjusting mechanism connected between the first roller unit and the second roller unit to adjust a distance between the first roller unit and the second roller unit, a vertical distance between the cylinder and the contact image sensor module being adjusted by adjusting the distance between the first roller unit and the second roller unit, so the cylinder being positioned on a top surface of the contact image sensor module, wherein when the cylinder is scanned, the first roller unit and the second roller unit rotate in the same direction, the cylinder is positioned on the first roller unit and the second roller unit, so the cylinder is driven by the first roller unit and the second roller unit to rotate.

2. The cylinder scanner as claimed in claim 1, wherein two opposite ends of the base protrude beyond the middle of the upper surface of the base to form two flanges, the two flanges are spaced from each other to form an accommodating space between the two flanges, two facing surfaces of the two flanges have two first sliding grooves and two second sliding grooves, the two first sliding grooves face towards each other, the two first sliding grooves are longitudinally aligned with each other, the two second sliding grooves face towards each other, the two second sliding grooves are longitudinally aligned with each other, the first roller unit includes a first roller element, two opposite ends of the first roller element are slidably mounted in the two first sliding grooves, the second roller unit includes a second roller element, two opposite ends of the second roller element are slidably mounted in the two second sliding grooves.

3. The cylinder scanner as claimed in claim 2, wherein the flange which is adjacent to a rear end of the contact image sensor module has an observation hole longitudinally penetrating through the flange, the observation hole is located to a rear end of the contact image sensor module.

4. The cylinder scanner as claimed in claim 2, wherein the first roller unit includes a first supporting plate and a first driving motor, the first supporting plate is mounted at one end of the first roller element, the first driving motor is mounted to the first supporting plate to drive the first roller element, the second roller unit includes a second supporting plate and a second driving motor, the second supporting plate is mounted at one end of the second roller element, the second driving motor is mounted to the second supporting plate to drive the second roller element.

5. The cylinder scanner as claimed in claim 4, wherein the adjusting mechanism includes a first rack connected to one end of the first roller unit, a second rack mounted to one end of the second roller unit, and a first adjusting gear disposed between the first rack and the second rack, the first adjusting gear is engaged with the first rack and the second rack simultaneously, the first rack has a first tooth surface which is defined at a top of an inner side of the first rack, the second rack has a second tooth surface which is defined at a bottom of an inner side of the second rack, the second tooth surface is located above the first tooth surface, the first tooth surface partially faces towards the second tooth surface.

6. The cylinder scanner as claimed in claim 5, wherein an inner side of the second tooth surface of the second rack is located above an inner side of the first tooth surface of the first rack, the inner side of the first tooth surface of the first rack faces towards the inner side of the second tooth surface of the second rack.

7. The cylinder scanner as claimed in claim 5, wherein an outer side of the first rack is fastened to a rear surface of the first supporting plate of the first roller unit, the inner side of the first rack is connected to an inner side of the first supporting plate of the first roller unit, an outer side of the second rack is fastened to a rear surface of the second supporting plate of the second roller unit, the inner side of the second rack is connected to an inner side of the second supporting plate of the second roller unit, the inner side of the first rack and the inner side of the second rack are located between the inner side of the first supporting plate and the inner side of the second supporting plate.

8. The cylinder scanner as claimed in claim 5, wherein the adjusting mechanism includes a knob gear, the knob gear is pivotally connected to an outer surface of the base to rotate the knob gear, and a transmitting gear connected between the knob gear and the first adjusting gear.

9. The cylinder scanner as claimed in claim 8, wherein the knob gear has a knob end, and a gear end connected with a middle of a front surface of the knob end, the gear end of the knob gear is engaged with the transmitting gear, the knob end of the knob gear is exposed outside to the outer surface of the base, a front end of the transmitting gear is engaged with a rear end of the first adjusting gear, a rear end of the transmitting gear is engaged with the gear end of the knob gear, a front end of the first adjusting gear is engaged between the first tooth surface of the first rack and the second tooth surface of the second rack.

10. The cylinder scanner as claimed in claim 5, wherein the adjusting mechanism includes a third rack, a fourth rack and a second adjusting gear, the third rack is coupled to the first roller unit, an outer side of the third rack is connected to the other end of the first roller unit, the first rack and the third rack are disposed to the two ends of the first roller unit, respectively, the fourth rack is coupled to the second roller unit, an outer side of the fourth rack is connected to the other end of the second roller unit, the second rack and the fourth rack are disposed to two ends of the second roller unit, respectively, the third rack has a third tooth surface which is defined at a bottom of an inner side of the third rack, the fourth rack has a fourth tooth surface which is defined at a top of an inner side of the fourth rack, the third tooth surface partially faces towards the fourth tooth surface, the second adjusting gear is disposed between the third rack and the fourth rack, and the second adjusting gear is engaged with the third rack and the fourth rack simultaneously.

11. The cylinder scanner as claimed in claim 10, wherein an inner side of the third tooth surface is located above an inner side of the fourth tooth surface, the inner side of the third tooth surface faces towards the inner side of the fourth tooth surface.

12. The cylinder scanner as claimed in claim 1, wherein the contact image sensor module is a rectangular shape.

13. The cylinder scanner as claimed in claim 1, wherein the contact image sensor module extends longitudinally, the first roller unit extends longitudinally, the middle of the upper surface of the base is lower than two opposite ends of the base, the first roller unit is slidably mounted between two facing surfaces of the two opposite ends of the base, the first roller unit slides along a transverse direction, the second roller unit extends longitudinally, the second roller unit is parallel to the first roller unit, the second roller unit slides along the transverse direction, the adjusting mechanism is connected between the first roller unit and the second roller unit to adjust the distance between the first roller unit and the second roller unit along the transverse direction.

14. The cylinder scanner as claimed in claim 1, further comprising a calibrator, the middle of the upper surface of the base being recessed downward to form a holding slot penetrating through one side surface of the base, the holding slot being located to one side of the contact image sensor module, the calibrator being detachably accommodated in the holding slot.

15. A cylinder scanner, comprising: a base, two opposite ends of the base protruding beyond a middle of an upper surface of the base to form two flanges; a contact image sensor module mounted on the middle of the upper surface of the base for scanning a cylinder which is placed to the middle of the upper surface of the base; a first roller unit slidably disposed above the middle of the upper surface of the base, the first roller unit being slidably mounted between two facing surfaces of the two flanges along a transverse direction; a second roller unit slidably disposed above the middle of the upper surface of the base, the second roller unit being slidably mounted between the two facing surfaces of the two flanges along the transverse direction; and an adjusting mechanism interconnected the first roller unit and the second roller unit to adjust a distance between the first roller unit and the second roller unit along the transverse direction, a vertical distance between the cylinder and the contact image sensor module being adjusted by adjusting the distance between the first roller unit and the second roller unit along the transverse direction, so the cylinder being positioned on a top surface of the contact image sensor module, wherein when the cylinder is scanned, the first roller unit and the second roller unit rotate in the same direction, the cylinder is positioned on the first roller unit and the second roller unit, so the cylinder is driven by the first roller unit and the second roller unit to rotate.

16. A cylinder scanner, comprising: a base, two opposite ends of the base protruding beyond a middle of an upper surface of the base to form two flanges; a contact image sensor module mounted on the middle of the upper surface of the base for scanning a cylinder which is placed to the middle of the upper surface of the base; a first roller unit slidably disposed above the middle of the upper surface of the base, the first roller unit being slidably mounted between two facing surfaces of the two flanges along a transverse direction; a second roller unit slidably disposed above the middle of the upper surface of the base, the second roller unit being slidably mounted between the two facing surfaces of the two flanges along the transverse direction; an adjusting mechanism interconnected the first roller unit and the second roller unit to adjust a distance between the first roller unit and the second roller unit along the transverse direction, a vertical distance between the cylinder and the contact image sensor module being adjusted by adjusting the distance between the first roller unit and the second roller unit along the transverse direction, so the cylinder being positioned on a top surface of the contact image sensor module; and an observation hole longitudinally penetrating through one of the flanges for detecting whether the cylinder abuts against the top surface of the contact image sensor module, wherein when the cylinder is scanned, the first roller unit and the second roller unit rotate in the same direction, the cylinder is positioned on the first roller unit and the second roller unit, so the cylinder is driven by the first roller unit and the second roller unit to rotate.
